(19) United States
(12) Patent Application Publication
(10) Pub. No.: US 2014/0030674 A1
(43) Pub. Date: Jan. 30, 2014

(54) PREFABRICATED IMMEDIATE NO-DRILL DENTAL IMPLANT

(71) Applicant: Hao Nguyen, Stockton, CA (US)

(72) Inventor: Hao Nguyen, Stockton, CA (US)

(21) Appl. No.: 13/751,135

(22) Filed: Jan. 27, 2013

Related U.S. Application Data
(60) Provisional application No. 61/591,273, filed on Jan. 27, 2012.

(51) Int. Cl. A61C 8/00

(52) U.S. Cl. CPC A61C 8/0037; A61C 8/0089
USPC 433/173; 433/201.1

(57) ABSTRACT

The invention concerns a dental implant comprising an apical end tapered conical portion axially connected to a coronal end cylindrical body wherein the coronal end cylindrical body has ridges on the proximal sides and has no ridges on the mesial and distal sides. The invention further concerns a series of manual pilot tools for the preparation of the tooth socket prior to implantation. The invention further concerns an undercut pilot tool for placing notches in the proximal walls of the tooth socket to prepare the socket to receive the dental implant. The invention also concerns methods for replacing a tooth with a prefabricated implant immediately upon removal of the tooth without the necessity for drilling by virtue of the initial retention of the prefabricated implant inside the jaw bone.

### RELATED APPLICATIONS

This application claims the benefit of U.S. Provisional Application No. 61/591,273, filed Jan. 27, 2012. The present application is related to U.S. Regular Patent Application entitled “Custom Dental Implants, Systems, Devices And Methods,” by Hao Van Nguyen, filed on the same day as this application, the content of which is expressly incorporated by reference herein in its entirety.

### BACKGROUND OF THE INVENTION

1. Field of the Invention

The present invention relates generally to the field of dentistry and particularly to the field of dental restorations, implants and prostheses. More specifically, the present invention is directed toward a dental implant, an implant system including dental devices and an implant method to install a dental implant.

2. Description of Related Art

Dental implants are the subject of much study. A typical dental implant system has three main components: 1) an implant, which is generally a titanium screw, 2) an abutment that attaches to the implant; and 3) a crown to restore the missing tooth. Some dental implant systems do not have the abutment, and the crown is connected directly to the implant. An artificial dental implant is implanted into the jawbone of a patient and, after bone has grown around the implant, an artificial tooth or bridge is affixed thereto by a screw or by cement. Traditionally, the implant is placed in the bone and covered with mucosa, but out of occlusal load, during a three to five month post-operative healing period, after which time a second surgery is performed to fit the desired prosthesis. It is more common now that implants and crowns are placed immediately following extraction. However, without the completion of osseointegration, there remains a risk of failure of the implant upon loading.

Generally, a void is created in the jaw bone by pre-drilling the jaw bone in order to accommodate a screw or projection on an artificial implant. Then an implant having a threaded projection is screwed into the bone of the prepared site so that the threaded projection is anchored in the drilled out area to secure the implant body in the socket and to provide an anchor to attach a replacement tooth. A hallmark of the currently accepted process of placing implants is the step of drilling the jaw bone to fit the shape of a portion of the implant. This method has many drawbacks and is not suitable for all implant situations.

Traditionally, implants have been selected for use from a commercially available supply of implants of generic shape, available in a standard series of sizes, rather than custom shaped anatomically to fit within the root cavity of a particular patient. Creation of a void or osteotomy by drilling in order to affix part of the implant therein is commonly viewed as necessary for securing the implant into the jaw bone.

While drilling has been treated as an essential step in implant surgery in order to insure stability of the implant and attached tooth, there are several drawbacks to drilling into the jaw bone. These drawbacks include, among other problems, necrosis due to overheating as a result of insufficient irrigation during drilling process, cortical plate perforation or fracture, poor implant and root proximity, and poor implant angulation.

Even where a patient is an ideal candidate for an implant, a dentist must use great care, skill and expertise when drilling into the jaw to avoid damaging vital jaw and face structures. The currently accepted implant methods that use drilling require significant skill when preparing the site for placement of the implant. Systems require the use of several drill bits and often complicated sequences that the clinician must follow to prepare the site. Additionally, the angulation of the drill, the diameter, and the length of the implant must all be taken into careful consideration to assure success in placing the implant.

Any time the jaw bone is drilled, heat will be generated and, with insufficient irrigation, the bone can be burned or otherwise damaged, which can result in bone necrosis and dental implant failure.

The process of drilling in order to place an implant always involves the risk of impinging on or invading other anatomical structures in the oral cavity, including, without limitation, the mental foramen and mental nerve, the inferior alveolar (mandibular) nerve, and the maxillary sinus.

Even where an implant is successfully positioned by drilling and has osseointegrated, attaching the replacement prosthesis may pose additional challenges because of the effect of the positioning of the implant as well as the angulation, of the final prosthesis that will attach to it. The positioning of the prosthesis is determined by the original implant placement. Sometimes, after osseointegration, it is discovered that an implant must be removed due to its positioning at an improper angle, resulting in the inability to affix a restorative prosthesis appropriately to satisfy dental esthetic requirements.

Positioning a dental implant by drilling can also necessitate additional procedures, such as sinus lifts or other bone grafting, particularly for upper molars and upper anteriors, which have stricter esthetic demands. The upper molar alveolar ridge often does not have sufficient bone height to accommodate drilling for placement of an implant due to the proximity of the floor of the maxillary sinus. Fixing an implant by use of a drill often requires a sinus lift to establish enough bone height to allow for the drilling. This procedure by itself adds the risk of more complications that threaten the success of the dental implant.

When drilling in order to place an implant, there is a risk that the drill bit will perforate the cortical bone if it is not angled properly during the osteotomy preparation phase. It can break the cortical bone plate if an implant is used that has a diameter that is too big for the jaw bone to support. The vibration of the implant drill can also break the cortical bone plate. Further, some patients have characteristics that increase the risks associated with drilling. Where there is insufficient bone or a condition that weakens the bone, drilling into the bone could result in irreparable damage, leaving no firm place to anchor the implant. When implanting in the upper jaw there is a risk of perforating the sinus, which exposes the patient to infection. Drilling also exposes the patient to the risk of nerve damage as well as damage to surrounding teeth and blood vessels. Some patients simply make poor candidates for traditional implant techniques because the structure of the bone underlying the root does not permit drilling for any number of reasons.

A wide variety of dental implants and systems are known. In response to the above shortcomings, some methods have been proposed to attempt to overcome them. Some solutions include forming a custom implant to match the shape of the particular patient's tooth socket. Such an approach requires a way to fabricate the custom implant quickly in order to be able to place it immediately after the extraction or within a limited time after the extraction so that no new bone will be formed in the extracted tooth socket. Moreover, the custom implant requires several additional steps. Additionally it is more expensive to manufacture custom implants for each application than to prefabricate implants in a selection of sizes from which a practitioner chooses the best match to the patient's tooth socket.

A significant need exists, therefore, for a prefabricatable implant device that may be mass produced without respect to the dimensions of a particular tooth socket, and that still may be securely implanted into the jaw bone without the necessity for drilling of the tooth socket prior to placement. A further need exists for a method of implanting the non-custom implant device and for tools that are useful for preparing the tooth socket for implantation of the corresponding implant.

Research shows that if the dental implant is made of titanium or titanium alloy and is secured tightly and immobile in the jaw bone osseointegration will occur within four to six months. It is an object of this invention to provide a dental implant system that can be fitted securely into an extraction socket with no drilling required while having sufficient initial stability or retention for osseointegration to occur.

In a preferred embodiment this invention is used for the replacement of single-rooted teeth with regular tooth morphology.

The difficulties and limitations suggested in the preceding are not intended to be exhaustive, but rather are exemplary of the many devices which demonstrate that, despite much attention in the art to improving dental implant methods and devices, the devices and methods in the art will admit to useful improvements.

### SUMMARY OF THE INVENTION

The present invention is directed toward a prefabricated dental implant for use in prosthetic procedures right after tooth extraction to avoid the drilling associated with the conventional dental implants.

It is an object of the present invention to provide a dental implant that provides initial stability without requiring drilling into the jawbone. In particular, the present invention encompasses a prefabricated dental implant that has been made to fit into the common geometry of a tooth socket, and that has additional stabilizing features to retain it in the tooth socket without the need for drilling. It is an additional object of the present invention to provide a set of dental tools for preparing the walls of the tooth socket to aid in retention of the prefabricated dental implant. It is yet another object of the present invention to provide methods for preparing a tooth socket for and installation of a prefabricated dental implant without drilling into the jaw bone.

It has been observed that the buccal cortical bone plate is thin and delicate compared to the lingual cortical bone plate. Moreover, the bucco-lingual dimension of the tooth socket is generally larger than the mesio-distal dimension of the tooth socket. This natural morphology of the tooth root and as a result the tooth socket has been taken into consideration in designing the dental implant and methods of implanting provided for in the present invention.

It has been observed that the cross-sections of single-rooted tooth sockets generally have a trapezoid shape (FIG. 1 & FIG. 1A), an ovoid shape (FIG. 2), an ovoid shape with a proximal concavity (FIG. 3), or two proximal concavities (FIG. 4). One common feature of these geometries is that the bucco-lingual dimension is often larger than the mesio-distal (proximal) dimension. In a clinical situation, immediately following tooth extraction, any concavity or concavities can be easily eliminated with the use of a surgical high-speed hand piece bur so that the largest proximal dimension (mesio-distal) is around the center of the tooth socket in the bucco-lingual dimension. The dotted circle in FIGS. 1, 1A, 2, 3 and 4 represents the diameter of the implant that fits into the tooth socket. In some cases, the proximal dimension may be larger than the bucco-lingual dimension for some upper centrals or cuspids. In such cases, the implant may be just inserted along the long axis of the tooth socket, without the need for rotation to set the implant in place, or a custom dental implant may be used.

It is an object of the present invention to provide a prefabricated dental implant allowing immediate placement following extraction without requiring drilling for placement, which implant has a conical cylindrical shape with a taper similar to the tooth socket so that it can be fit into the tooth socket shortly after extraction. It is an additional object of the present invention to have surface features on the dental implant that aid in securing the dental implant in the tooth socket, including, without limitation, a partial thread pattern that protrudes into the buccal and lingual sides of the tooth socket so that when the above implant is seated to its full length it can be rotated clockwise with manual wrench so that the thread pattern can cut and engage into the proximal walls of the tooth socket and hence secure the implant inside the tooth socket for initial stability.

It is an object of the present invention to provide a dental implant system that fits into the center of the tooth socket. This implant has a notch or thread pattern on the buccal and lingual sides. When the implant is placed in position in the tooth socket and rotated 90 degrees clockwise, these thread patterns will engage into the proximal walls (the mesial and the distal walls) to provide initial stability or retention for the implant during osseointegration that will happen after the implant placement.

It is further an object of the present invention to provide the dental implant with different dimensions that match those of the tooth socket at the root length as well as the mesio-distal dimension at the center of the tooth socket. As a result, there will be a series of implants for each single-rooted tooth, including, without limitation, maxillary centrals, maxillary laterals, maxillary cuspids, mandibular centrals and laterals, mandibular cuspids, and mandibular bi-cuspids.

It is also an object of the present invention to provide the measuring tools to determine the anatomical length of the tooth socket and the mesio-distal dimension of the tooth socket right after the tooth extraction. These two parameters may be used to choose the dental implant of the present invention that will fit snuggly into a particular tooth socket.

It is another object of the present invention to provide a series of manual tools to safely prepare the tooth socket by removing soft tissue in the apical ⅓, the middle ⅓ and the coronal ⅓ of the tooth socket prior to insertion of an implant of the present invention.

It is also an object of the present invention to provide a tool to create a counter-sink that may be used as a guiding plane for the insertion to the correct depth of subsequent preparation tools. In one embodiment of the invention is the first tool to be introduced into the tooth socket.

It is yet a further object of the present invention to provide a tool to create notches in the walls of the tooth socket to accommodate ridges (threads) on the no-drill dental implant. These notches or undercuts are designed to provide the initial stability of the implant after placement needed for the osseointegration to happen later.

It is another object of the present invention to provide these tools with similar dimensions to the final dental implant to ensure a smooth insertion and a snug fit of the implant after the tooth socket has been prepared using these tools. The tools are designed to remove any irregularities in the tooth socket and therefore ensure the smooth insertion of the implant into the tooth socket.

In one aspect of the present invention, one or more undercut notches can be place in the mesio-distal walls of the tooth socket from the buccal to the lingual direction using an undercut tool. Then a dental implant having one or more ridges on the medial and distal sides that also run in the buccal and lingual direction and that fit into the undercut notches in the tooth socket can be placed into the tooth socket so that the ridges lock into the notches for stability.

In another aspect of the invention a dental implant is provided that has a thread pattern on the proximal sides only. The implant can be placed into a tooth socket that has not been prepared with any undercut notches. The implant is first positioned in the socket so that the threads are oriented in the generally wider bucco-lingual dimension of the socket, and then it is rotated approximately 90 degrees with some pressure so that the thread pattern cuts into the proximal walls thereby securing the implant in the socket.

When the dental implant is placed with no undercut preparation, the threads which are parallel to each other form a pattern that can be either perpendicular to the apical-coronal axis of the implant or slightly off of perpendicular so that one side of the pattern slants slightly toward the apical end of the implant. If the threads are perpendicular to the length of the implant, then when the implant is turned inside the tooth socket it will engage into the walls without advancing into the tooth socket. For even more initial retention, an implant having a slanted thread will not only engage into the walls but also advance into the tooth socket when it is rotated with some torque inside the tooth socket. In one embodiment the threat pattern is slanted so that in ¼ of the circumference of the implant the threads move down between 0.25 and 0.5 mm, and the implant is then preferably positioned between 0.25 mm and 0.5 mm above the apex of the socket prior to rotating 90 degrees, so that during the 90 degree rotation the implant can advance into the tooth socket.

In a preferred embodiment of the present invention, the thread dimension of the thread pattern on the dental implant for use with no undercut preparation will follow the dimension of the tooth socket as well as the taper degree of the bucco-lingual geometry so that the threads closest to the coronal section project farther from the body of the implant than the rest of the threads, which are incrementally smaller as toward the apical end of the implant.

The dental implant system of the present invention can be pre-manufactured and a selection of implants and tools, individually or in the form of a kit, made available for the clinician at the time of tooth extraction. The clinician can maintain a selection of the implants for different tooth sockets with different sizes so that the implant can be placed immediately after tooth extraction. If the clinician chooses not to maintain a selection of tools and implants to avoid inventory cost, the implants and tools could be ordered following tooth extraction using measured parameters (tooth type, diameter and length). With no motorized hand piece equipment and accessories required for drilling, and no need for an implant inventory, this implant system could reduce the cost of implant dentistry significantly.

If the implant is placed immediately following tooth extraction, there is very little additional trauma to the structure of the tooth socket and surrounding hard and soft tissues. This process will therefore facilitate faster biological healing as well as less post-operative surgical discomfort for the patient as compared to traditional implants which necessitate drilled osteotomy for implant placement.

The tooth socket preparation steps for this dental implant system are minimally invasive and simple as compared to traditional implants with osteotomy drilling. From start to finish, all the steps from preparing the tooth socket to placing the implant itself can be performed manually or digitally. These steps are simple and straightforward. The dental implant system of the present invention is user-friendly.

This dental implant system of the present invention is intended to avoid placing additional pressure on the buccal and lingual cortical bone plate, as is often an element of traditional implant procedures. Because in an embodiment of the present invention retentive notches are prepared on the proximal walls, where the bone is supported by the adjacent teeth, the methods of the present invention represent an improvement in safety and stability of the implant system. Even when placing an implant in a trapezoidal tooth socket with no pre-prepared undercuts on the proximal walls, the lingual pressure on the implant when it is turned inside the tooth socket to engage into the proximal walls is actually on the lingual side of the proximal walls, preserving and protecting the more delicate buccal bone plate.

Traditional implants depend largely on the clinician's skill to have the correct pilot drill as well as all subsequent enlarging drills and thread pattern drill angulation. Complications from incorrect angulation can result is cortical plate perforation, cortical plate fracture, close root proximity with adjacent tooth, inability to restore the implant especially in esthetic zone. The dental implant system of the present invention follows the natural tooth angulation and the emerging profile from the extracted tooth socket, which is an improvement over the guess work of previous techniques in determining the three dimensional angulation of the implant inside the jaw bone.

Bone necrosis due to overheating during drilling for osteotomy with traditional implants is another complication that can be avoided with the methods of the present invention because hand instruments are used for all pilot tools and the implant placement requires only digital forces which are not capable of burning bone or soft tissue in the tooth socket.

If the dental implant fails to osseointegrate or any reasons that the clinician needs to retrieve the implant, it requires only the simple step of disengaging it from proximal walls by rotating the implant 90 degrees prior to lifting the implant out of the socket. For implants having a slanted thread pattern the implant would be rotated in the reverse direction to the direction the implant was rotated to install it. For example, if the implant was rotated clockwise in order to lock it into the tooth socket, the clinician would rotate the implant counter clockwise in order to loosen it from the tooth socket so that it could be easily removed.

This dental implant system provides a simpler solution for the laboratory and the restoring clinician. Even before the implant is placed into tooth socket, the angulation of the final implant should be accurate within two to four degrees. If provided with 3-D imaging of a tooth socket, such as that obtained using cone beam technology, a dental laboratory can custom make an abutment for an implant of the present invention before the implant is even placed. In the case of multiple units, the laboratory can make custom abutments with high accuracy to ensure a common path of insertion or withdrawal. This step is preferred for esthetic restorative cases in order to obtain well aligned abutment crowns.

A prefabricated immediate no-drill implant and prefabricated immediate no-drill implant sections can be fabricated in a number of ways known in the art. In a preferred embodiment of the present invention where a variety of sizes of the implants of the present invention is to be made, the dimensions of the implants are obtained by statistical analysis of the dimensions of several individuals tooth roots for each type of single-rooted tooth to determine an appropriate range of sizes for the implants, and then a plurality of implants of gradually increasing length and/or circumference can be produced within the range of commonly occurring tooth socket dimensions. For example, in one embodiment a set of implants of varying size is provided for each single-rooted maxillary lateral, where the implant diameters range from 4.0 to 5.0 mm in increments of 0.25 mm, and the length of the implants range from 10 mm to 14 mm in increments of 1 mm. In one embodiment, a kit containing a plurality of implants of the present invention of varying size will contain implants that vary in diameter by increments of approximately 0.25 mm and that vary in length in increments of approximately 1 mm.

The implants of the present invention can be composed of any resilient material that is nontoxic to humans or to the particular mammal for which the implant is to be made. In a preferred embodiment the implant of the present invention comprises a titanium alloy.

In some cases it may be desirable to increase the initial retention of an implant or to encourage the speed of osseointegration after implantation. Thus, in one embodiment of the present invention, the surface of the implant of the present invention has one or more features that improves retention or encourages osseointegration.

In a preferred embodiment an implant of the present invention has at least one surface configuration that increases at least a portion of the outer surface area that is intended to contact the tooth socket, including, but not limited to: a roughened outer surface, such as that created by machining, grit-blasting, etching, plasma spraying, or any other method of roughening the surface material of the implant; ribs, including without limitation parallel ridges or helical threads; and pores. Such surface roughening is believed to encourage more complete and more rapid osseointegration of the implant.

In one embodiment of the present invention, the surface of the implant of the present invention is coated with a biocompatible osseoconductive material to aid osseointegration of the implant in the jaw bone.

After implantation, there is a period of time over which osseointegration occurs, increasing stability of the implant. An implant of the present invention may be constructed as a one-piece implant which is intended to be exposed to the oral cavity during the osseointegration period, or as two-piece implant system, where the root portion of the implant is placed in the socket and buried under the soft tissue during the osseointegration period, after which it is uncovered and an abutment portion of the implant that will act as a platform for attachment of the restorative phase is affixed to the root portion of the implant. The restorative phase artificial tooth is attached to the abutment by any known means, including, without limitation, by a screw inserted into internal threads in the abutment and in the prefabricated immediate no-drill implant. Embodiments of the implant of the present invention are contemplated that can accommodate the attachment of an abutment, an artificial tooth, or both by any known means including, without limitation, by the incorporation of internal threads at the coronal end of the implant to permit an abutment or artificial tooth having a threaded projection to be screwed into the implant at the coronal end.

In a preferred embodiment of the present invention, where the prefabricated immediate no-drill implant does not have threads or pores on the surfaces that are intended to contact the tooth socket in order to encourage rapid osseointegration, an implant is fitted with a healing cap on its coronal end and buried under the soft tissue during the osseointegration period. After sufficient osseointegration, the implant is then recovered and attached to an implant abutment.

An implant of the present invention can be held in the socket with the aid of osseoconductive material such PepGen P-15 flow by Dentsply™ (York, Pa.), or with the aid of non-absorbable suture and/or guided tissue regeneration (GTR) membrane.

The present invention encompasses a dental implant comprising an apical end tapered conical portion axially connected to a coronal end cylindrical body wherein the coronal end cylindrical body has ridges on the proximal sides and has no ridges on the mesial and distal sides.

The present invention further encompasses a kit comprising a plurality of dental implants of predetermined sizes and shapes substantially corresponding in size and shape to natural tooth roots selected from the group consisting of maxillary and mandibular central incisors, lateral incisors, canines, and premolars, said dental implants comprising an apical end tapered conical portion axially connected to a coronal end cylindrical shaft wherein the coronal end cylindrical shaft has ridges on the proximal sides and has no ridges on the mesial and distal sides.

The present invention further encompasses a kit of tools for preparing a tooth socket for insertion of an implant, comprising a countersink tool, an apical ⅓ pilot tool, a middle ⅓ pilot tool and an undercut pilot tool, wherein each of said plurality of pilot tools is shaped to remove bone from a different portion of a tooth socket.

The present invention further encompasses a method for installing a dental implant into a tooth socket, comprising: providing a tooth socket having a coronal portion and an apical portion, proximal walls and bucco-lingual walls, a dental implant having a coronal portion connected to a tapered portion by a cylindrical portion, wherein said cylindrical portion has ridges projecting in a 90 degree arc around each of two opposing sides of the cylindrical portion; placing the dental implant in the tooth socket so that the ridges are oriented toward the bucco-lingual walls; and rotating the implant approximately 90 degrees in the tooth socket.

The present invention further encompasses an undercut pilot tool, comprising: a shaft having a first end, a second end, and a long axis; a handle at the first end of the shaft; a guiding tip at the second end of the shaft, wherein a long axis of the undercut pilot shaft extends through the handle, the undercut pilot shaft and the guiding tip; a plurality of long cutting blades, and a plurality of short cutting blades, wherein the long cutting blades and the short cutting blades are affixed to the shaft between the handle and the guiding tip and project out from the shaft substantially perpendicular to the long axis of the shaft.

The present invention further encompasses a dental implant kit, comprising: a cylindrical tapered shaped implant having two proximal sides, and having threading only on the proximal sides; a countersink pilot tool; an apical ⅓ pilot tool; a middle ⅓ pilot tool; a coronal ⅓ pilot tool; and an undercut pilot tool.

The present invention further encompasses a method of fitting a dental implant in a tooth socket, comprising: providing a tooth socket having a mesiodistal dimension that is shorter than a buccolingual dimension, and having an apical portion, a middle portion and a coronal portion; a dental implant having a coronal end, an apical and an approximately cylindrical middle portion, wherein said middle portion has two proximal surfaces opposite each other and a mesial surface opposite to a distal surface, and having a ridge on the proximal surfaces but not on the mesial surface or distal surface; a countersink tool, an apical ⅓ pilot tool, a middle ⅓ pilot tool, a coronal ⅓ pilot too, and an undercut pilot tool; Inserting the countersink tool into the socket fully and rotating the countersink tool to create a countersink; Inserting the apical ⅓ pilot tool into the tooth socket and rotating to shape the apical portion of the tooth socket; inserting the middle ⅓ pilot tool into the tooth socket and rotating to shape the middle portion of the tooth socket; inserting the coronal ⅓ pilot tool into the tooth socket and rotating to shape the coronal portion of the tooth socket; inserting the undercut pilot tool into the tooth socked and rotating to create an undercut notch in the tooth socket; inserting the dental implant fully into the tooth socket while the ridges are oriented in the bucco-lingual dimension, and rotating the dental implant approximately 90 degrees to orient the ridges in the mesio-distal dimension.

The present invention encompasses a dental implant comprising an apical end tapered conical portion axially connected to a coronal end cylindrical body wherein the coronal end cylindrical body comprises: two proximal sides, a mesial side, and a distal side; and wherein the coronal end cylindrical body has a ridge on each proximal side and has no ridges on the mesial side and distal side. In one embodiment the coronal end cylindrical body has more than one ridge on each proximal side. In another embodiment, the ridges project in a 90 degree arc around each proximal side.

Also contemplated is a method for installing a dental implant into a tooth socket, comprising: providing a tooth socket having proximal walls and bucco-lingual walls, a dental implant comprising a coronal end, an apical end and an approximately cylindrical portion between said coronal end and said apical end, wherein said approximately cylindrical portion comprises two proximal surfaces, a mesial surface and a distal surface, and wherein the approximately cylindrical portion further comprises a ridge projecting from each proximal surface and no ridge projecting from the mesial surface or the distal surface; placing the dental implant in the tooth socket so that the ridge is oriented toward the bucco-lingual walls; and rotating the implant until the ridge is oriented toward the proximal walls in the tooth socket. In one embodiment said tooth socket has a mesiodistal dimension and a buccolingual dimension, and wherein said mesiodistal dimension is shorter than said buccolingual dimension. In one embodiment, the tooth socket further comprises a coronal portion, an apical portion, and a middle portion between said apical portion and said coronal portion; and further providing: a countersink tool, an apical ⅓ pilot tool, a middle ⅓ pilot tool, a coronal ⅓ pilot too, and an undercut pilot tool; the method further comprising, before placing the dental implant in the tooth socket, inserting the countersink tool into the socket fully and rotating the countersink tool to create a countersink; inserting the apical ⅓ pilot tool into the tooth socket and rotating to shape the apical portion of the tooth socket; inserting the middle ⅓ pilot tool into the tooth socket and rotating to shape the middle portion of the tooth socket; inserting the coronal ⅓ pilot tool into the tooth socket and rotating to shape the coronal portion of the tooth socket; inserting the undercut pilot tool into the tooth socked and rotating to create an undercut notch in the tooth socket. In one embodiment said implant is rotated until the ridge is fully engaged in the undercut notch.

In a specific embodiment, after the implant is rotated it is held in place by the engagement of the ridge and the undercut notch.

Also contemplated is a dental implant kit, comprising: a cylindrical tapered shaped implant having two proximal sides, and having threading only on the proximal sides; a countersink pilot tool; a pilot tool shaped to remove tissue and bone from the sides of a tooth socket when rotated; and an undercut pilot tool. In one embodiment, the pilot tool comprises an apical ⅓ pilot tool; a middle ⅓ pilot tool; and a coronal ⅓ pilot tool. In a specific embodiment the apical 1/3 pilot tool, the middle ⅓ pilot tool, and the coronal ⅓ pilot tool are each shaped to remove bone from a different portion of a tooth socket.

In another embodiment said undercut pilot tool comprises: a shaft having a first end, a second end, and a long axis; a handle at the first end of the shaft; a guiding tip at the second end of the shaft, wherein a long axis of the undercut pilot shaft extends through the handle, the undercut pilot shaft and the guiding tip; a plurality of long cutting blades, and a plurality of short cutting blades, wherein the long cutting blades and the short cutting blades are affixed to the shaft between the handle and the guiding tip and project out from the shaft substantially perpendicular to the long axis of the shaft.

### BRIEF DESCRIPTION OF THE SEVERAL VIEWS OF THE DRAWINGS

The foregoing and other objects or features and advantages of the present invention will be made apparent from the following description of embodiments, although not exclusive, embodiments of the invention and from the drawings in which

FIG. 1 is a sectional view of a tooth socket following extraction, the cross section made at the alveolar bone level below the soft tissue, showing the approximate geometry of a triangle with the centered mesio-distal dimension smaller than the centered bucco-lingual dimension. This anatomy is seen in maxillary centrals, maxillary laterals, maxillary cuspids, mandibular cuspids and mandibular bicuspids.

FIG. 1A is a sectional view of a tooth socket following extraction, the cross section made at the alveolar bone level below the soft tissue, showing the approximate geometry of a triangle with the centered mesio-distal dimension larger than the centered bucco-lingual dimension. This anatomy can be seen in some maxillary centrals, maxillary cuspids, mandibular cuspids and mandibular bicuspids.

FIG. 2 is a sectional view of an anatomically extracted tooth socket, the cross section made at the alveolar bone level below the soft tissue, showing the approximate geometry of an ovoid. This anatomy is seen in mandibular centrals, mandibular laterals, mandibular bicuspids and maxillary bicuspids.

FIG. 3 is a sectional view of an anatomically extracted tooth socket, the cross section made at the alveolar bone level below the soft tissue, showing the approximate geometry of an ovoid with one concavity. This anatomy is seen in mandibular centrals, mandibular laterals, and maxillary bicuspids.

FIG. 4 is a sectional view of an anatomically extracted tooth socket, the cross section made at the alveolar bone level below the soft tissue, showing the approximate geometry of an ovoid with two concavities. This anatomy is seen in mandibular centrals, mandibular laterals, mandibular bicuspids and maxillary bicuspids.

FIG. 5 is a perspective view of the countersink tool of the present invention.

FIG. 6A is a sectional view of the countersink tool of FIG. 5 inserted in a tooth socket so that the guide blades are oriented in the mesio-distal direction and the cutting blades are oriented in the wider, bucco-lingual direction, the cross section taken at the alveolar bone crest of the tooth socket and viewed looking toward the apex of the socket. The cutting blades of the countersink tool are situated at the alveolar bone crest of the tooth socket such that when the countersink pilot tool is rotated, the cutting blades will cut a countersink into the bone at the alveolar bone crest of the tooth socket.

FIG. 6B is a sectional view of the same countersink tool of FIG. 6A, where the countersink tool has been rotated from its initial position shown in FIG. 6A to engage one pair of the cutting blades with the mesio-distal walls of the alveolar bone crest in order to place a countersink in the area of the alveolar bone crest of the tooth socket.

FIG. 7 is a sectional view of the countersink tool of FIG. 5 shown fully inserted into a tooth socket with the countersink created at the alveolar bone crest.

FIG. 8 is a sectional view of a pilot tool of the present invention for preparing the apical ⅓ of the tooth socket for insertion of an implant of the present invention, inserted fully into a tooth socket so that the guiding plane designed to fit into the countersink created by the countersink tool is resting on the countersink and so that the cutting blades are positioned at the apical ⅓ of the tooth socket.

FIG. 8A is a sectional view, looking into the tooth socket, of the pilot tool of FIG. 8 inserted in the tooth socket.

FIG. 9 is a sectional view of a pilot tool of the present invention for preparing the middle ⅓ of the tooth socket for insertion of an implant of the present invention, inserted fully into a tooth socket, wherein the guiding plane designed to fit into the countersink created by the countersink tool is resting on the countersink, wherein the cutting blades are positioned at the middle ⅓ of the tooth socket, and wherein the non-cutting guiding end is resting at the apex of the tooth socket.

FIG. 9A is a sectional view, looking into the tooth socket, of the pilot tool of FIG. 9 inserted in the tooth socket.

FIG. 10A is a prospective view of an undercut pilot tool of the present invention.

FIG. 10B is a prospective view from a different angle of the undercut pilot tool of FIG. 10A.

FIG. 10C is a prospective view from a different angle of the undercut pilot tool of FIG. 10A and FIG. 10B.

FIG. 10D is a sectional view. Looking into the tooth socket of the undercut pilot tool of FIGS. 10A-10C.

FIG. 11A illustrates a sectional view of a tooth socket after extraction of a tooth, as viewed from the buccal toward the lingual direction.

FIG. 11B shows the same sectional view of the tooth socket of FIG. 11A, after a countersink tool of the present invention has been used to place a countersink in the tooth socket.

FIG. 11C shows the same sectional view of the tooth socket of FIG. 11B following preparation and enlargement of the apical ⅓ of the tooth socket by use of a pilot tool of the present invention.

FIG. 110 shows the same sectional view of the tooth socket of FIG. 11C following preparation and enlargement of the middle ⅓ of the tooth socket by use of a pilot tool of the present invention.

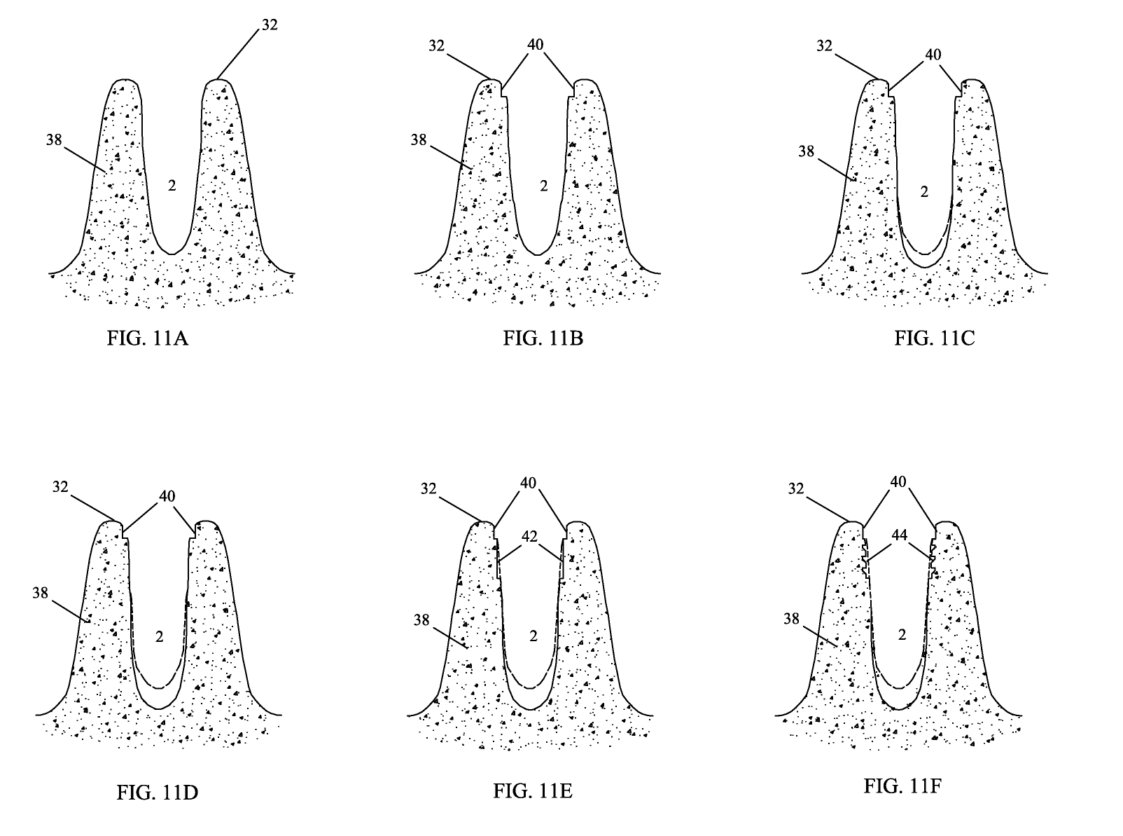

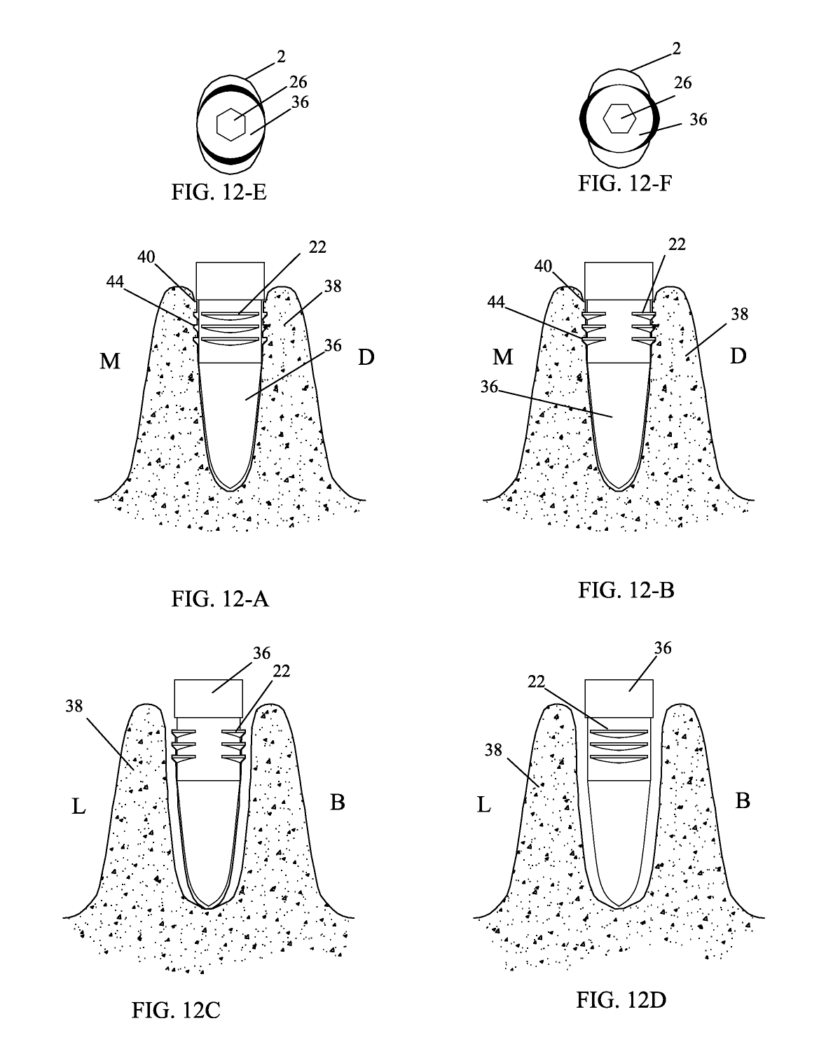

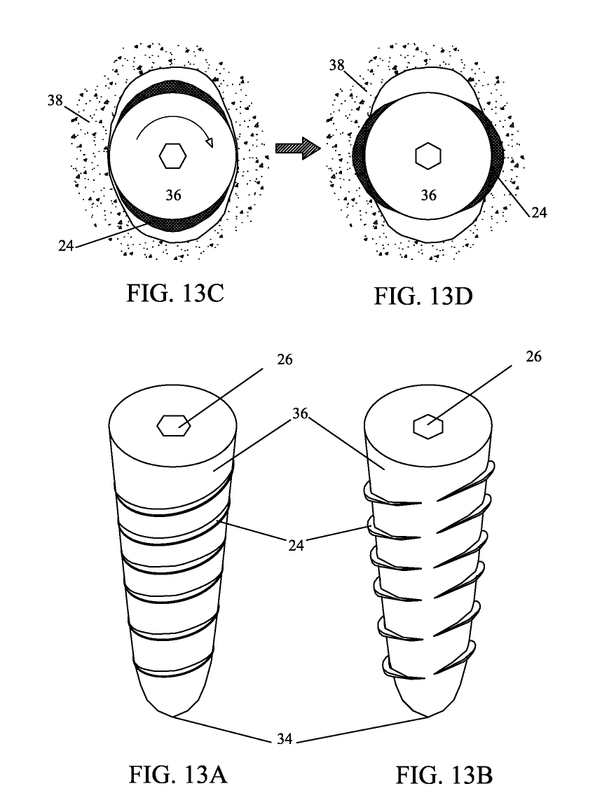

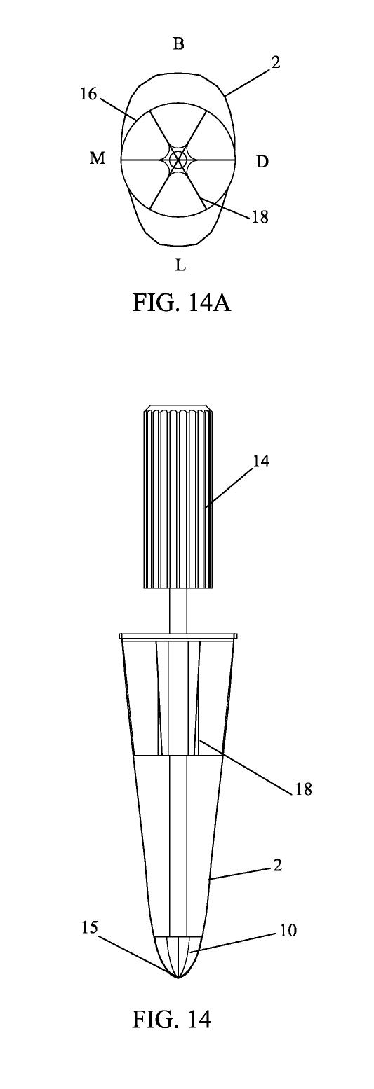

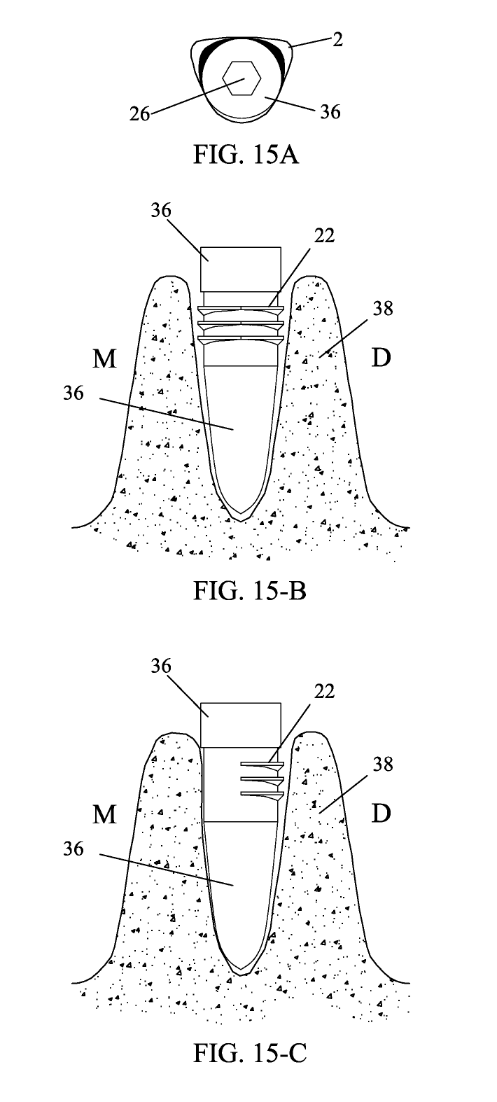

FIG. 11E shows the same sectional view of the tooth socket of FIG. 11D following preparation of the socket with the smaller blades of an undercut tool of the present invention.

FIG. 11F shows the same sectional view of the tooth socket of FIG. 11E following creation of the undercut notches in the tooth socket by use of the larger blades of an undercut tool of the present invention.

FIG. 12A shows a perspective view of a prefabricated immediate no-drill dental implant of the present invention inserted into a tooth socket to full length, with bone viewed in cross section, as viewed from the buccal toward the lingual direction.

FIG. 12B shows a shows a perspective view of the implant and tooth socket shown in FIG. 12A, with bone viewed in cross section, after the dental implant has been rotated 90 degrees clockwise, locking the ridges on the implant into the undercut notches placed in the walls of the tooth socket, also as viewed from the buccal toward the lingual direction.

FIG. 12C shows a shows a perspective view of the implant and tooth socket shown in FIG. 12A, as viewed from the proximal direction, with bone viewed in cross section.

FIG. 12D shows a perspective view of the implant and tooth socket shown in FIG. 12B, as viewed from the proximal direction, with bone viewed in cross section.

FIG. 12E shows a perspective view (from above) of the implant shown in FIG. 12A.

FIG. 12F shows a perspective view (from above) of the implant shown in FIG. 12B.

FIG. 13A is a perspective view of one embodiment of a prefabricated immediate no-drill dental implant of the present invention for use when no undercut pilot tool will be used.

FIG. 13B is a perspective view of the prefabricated immediate no-drill dental implant of FIG. 13A, showing that the ridges do not completely encircle the implant in this embodiment.

FIG. 13C is a perspective view (viewed from the top) of the implant shown in FIG. 13A, after it has been inserted in a tooth socket so that the threads on the implant are pointed in the direction of the widest portion of the tooth socket.

FIG. 13D is a perspective view (from above) of the implant shown in FIG. 13C after it has been rotated 90 degrees clockwise so that the threads cut into the proximal walls of the tooth socket and engage the implant inside the tooth socket.

FIG. 14 is a perspective view of the coronal pilot tool. This tool will be used if no pre-prepared undercut notches are preferred by the clinician. It is used to ensure that the implant coronal ⅓ dimension matches that of the tooth socket.

FIG. 14A is a perpendicular sectional view of the coronal pilot tool in FIG. 14 inserted inside the tooth socket.

### DETAILED DESCRIPTION OF THE PREFERRED EMBODIMENTS

The following is a list of reference numerals used throughout:

REFERENCE NUMERALS

| M | Mesial direction |
|---|---|
| D | Distal direction |
| B | Buccal direction |
| L | Lingual direction |
| 2 | tooth socket |
| 4 | medial-distal diameter |
| 6 | Proximal concavity |
| 8 | Guiding blade |
| 9 | Cutting blade |
| 10 | Guiding tip |
| 11 | shaft |
| 12 | Circular band |
| 13 | Cut plane |
| 14 | Handle |
| 15 | Apex of the socket |
| 16 | Guide plane |
| 18 | Pilot cutting blade |
| 20 | Long undercut blade |
| 22 | Ridges on implant |
| 24 | Interrupted circumferential thread |
| 26 | Hexagonal recess |
| 28 | Short undercut blade |
| 32 | Alveolar crest |
| 34 | Implant apical end |
| 36 | Implant body |
| 38 | Alveolar bone |
| 40 | Countersink |
| 42 | Proximal convex cut |
| 44 | Undercut notches |

Mention is made throughout of the proximal, apical, coronal, mesio-distal or bucco-lingual sides of the implants of the present invention, which descriptions refer to the direction that the various areas of the implant will face if the implant is positioned in a tooth socket in its intended final orientation for use as a prosthetic fixture. These descriptions are used for ease of understanding and are not intended to limit the scope of the invention to implants that are positioned in a tooth socket.

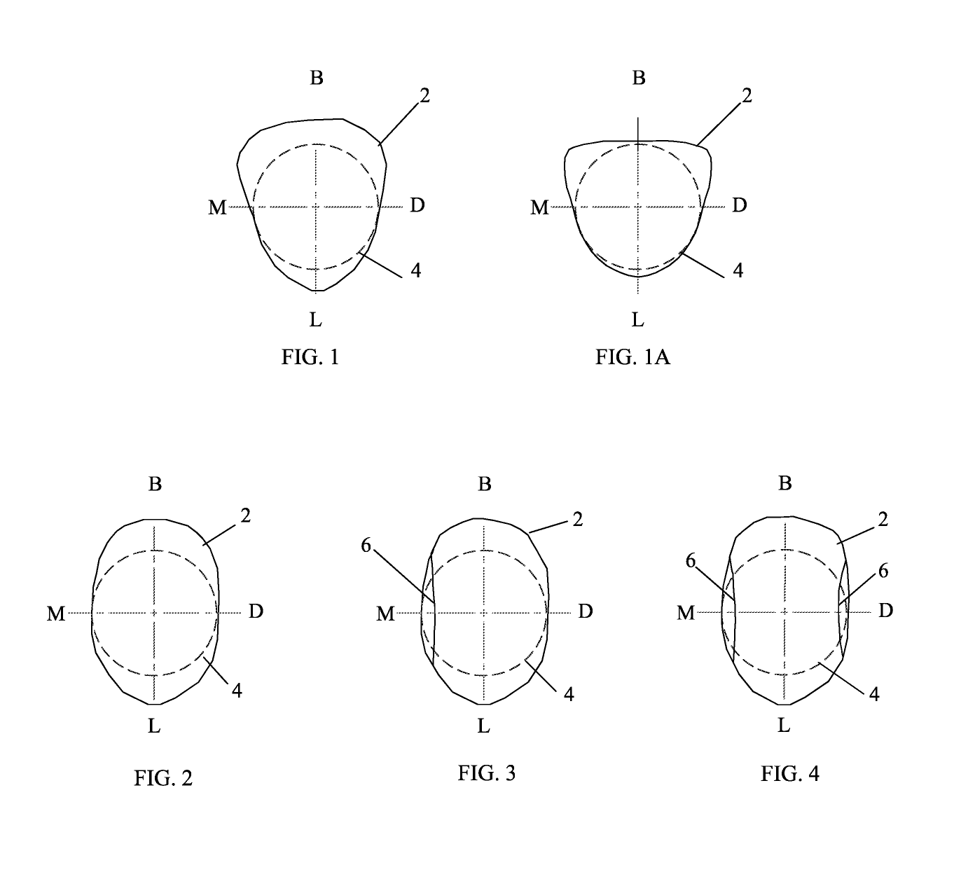

FIGS. 1-4 show the cross sections of several different common types of tooth sockets 2 after extraction, the cross sections taken at the alveolar bone level just below the soft tissue. FIGS. 1-4 also show what the medial-distal diameter 4 of the tooth socket would be following preparation of this tooth socket to receive an implant of the present invention, as represented by the dotted circle in each figure, except in FIG. 1A, It is notable that in each of these common tooth socket anatomies the medial M distal D dimension is smaller than the buccal B lingual L dimension, which trait the present invention is uniquely suited to utilize.

FIG. 1 is a sectional view of a tooth socket 2, exhibiting the approximate geometry of a triangle. This anatomy is commonly seen in maxillary centrals, maxillary laterals, maxillary cuspids, mandibular cuspids and mandibular bicuspids. As represented by the dotted circle, this figure also shows what the medial-distal diameter 4 of the tooth socket would be following preparation of this tooth socket to receive an implant of the present invention.

FIG. 1A is a sectional view of a tooth socket 2, exhibiting the approximate geometry of a triangle. This anatomy is a variation of FIG. 1 in which the mesio-distal dimension is larger than the bucco-lingual dimension. For this configuration it is preferable to provide a full custom implant. This anatomy sometimes can be found in maxillary centrals and cuspids.

FIG. 2 is a sectional view of a tooth socket 2 showing the approximate geometry of an ovoid. This anatomy is commonly seen in mandibular centrals, mandibular laterals, mandibular bicuspids and maxillary bicuspids. Sometimes, this tooth socket displays a proximal concavity 6. FIG. 3 is a sectional view of a tooth socket 2 showing the approximate geometry of an ovoid with one concavity. This anatomy is commonly seen in mandibular centrals, mandibular laterals, and maxillary bicuspids. FIG. 4 is a sectional view of a tooth socket 2 showing the approximate geometry of an ovoid with two concavities. This anatomy is commonly seen in mandibular centrals, mandibular laterals, mandibular bicuspids and maxillary bicuspids. This tooth socket also displays a proximal concavity 6.

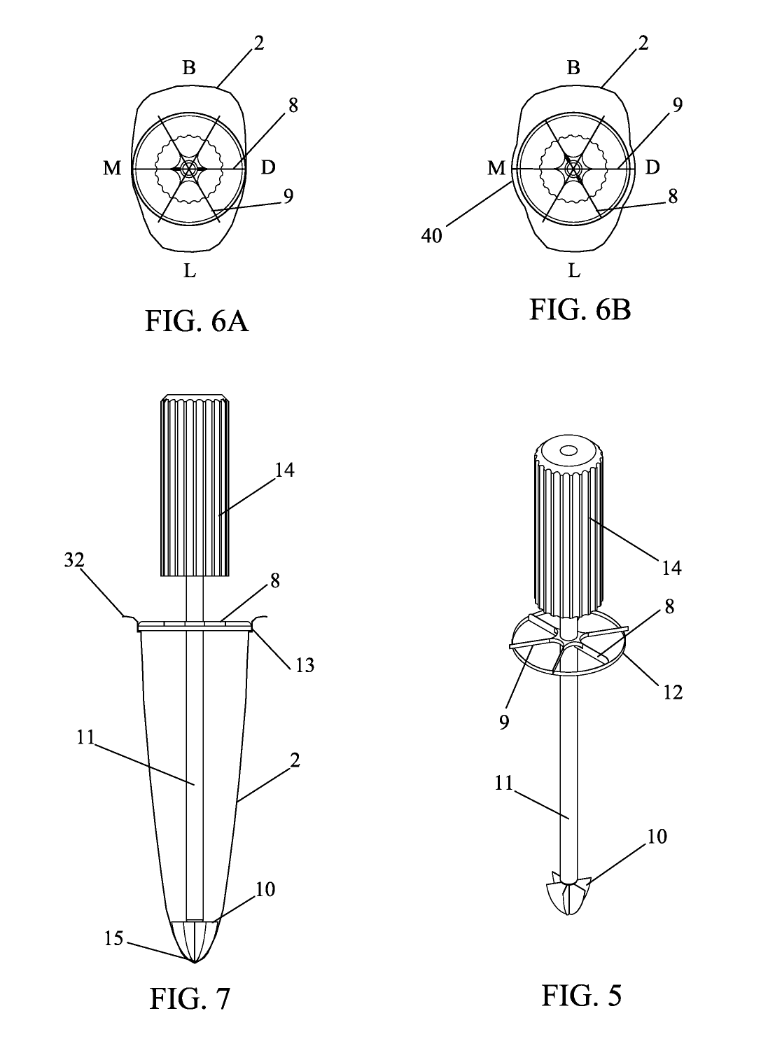

FIG. 5 illustrates a perspective view of the first pilot tool, the countersink tool. This tool is to create a countersink at the alveolar crest to be used as a guide and a stop for subsequent pilot tools as well as the placement of the dental implant. It has a non-cutting guiding tip 10, a shaft 11, a handle 14, a circular band 12 on which there are guiding blades 8 and cutting blades 9.

FIG. 6A illustrates a sectional view, viewed from above the cutting plane 13 in the apical direction, of a countersink tool placed in a tooth socket 2 when the countersink tool is just inserted into the tooth socket.

FIG. 6B illustrates a sectional view, viewed from above the cut plane 13 in the apical direction, of a countersink tool placed in a tooth socket 2 after the countersink tool has been rotated in the tooth socket until a countersink 40 has been cut into the alveolar crest 32 of the tooth socket 2. By rotating the countersink tool back and forth more than 60 degrees within the tooth socket, the cutting blades 9 will cut into the coronal surface of the alveolar bone 2 to create a countersink 40. This countersink 40 is used as a guiding stop for subsequent pilot tools as well as the insertion of the implant.

FIG. 7 illustrates the complete seating of the countersink tool in the tooth socket 2. When a correctly sized countersink tool is advanced into a tooth socket, the first contact point will be between the cutting plane 12 and the alveolar crest 32. As the countersink tool is rotated clockwise and counterclockwise, the cutting blades 9 will cut away at the alveolar crest 32, allowing the countersink tool to advance into the tooth socket 2 until the guiding tip 10 is stopped at the apex of the socket 15 preventing the countersink tool from progressing further.

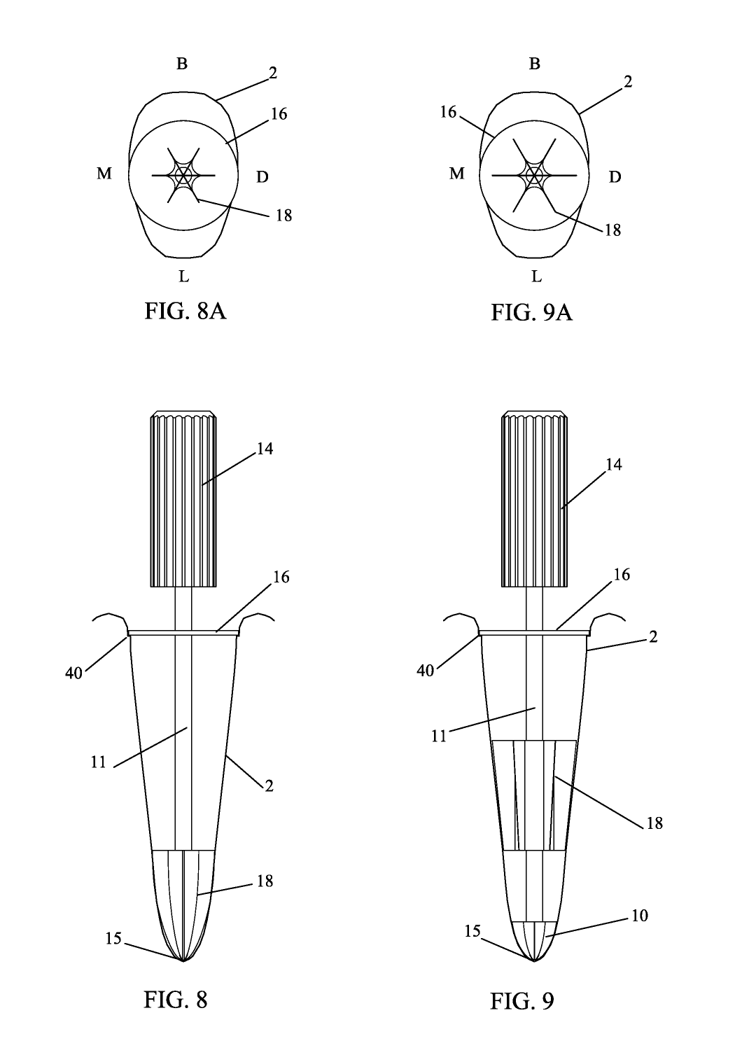

FIG. 8 shows a perspective view of a pilot tool for preparing the apical ⅓ of the tooth socket for insertion of an implant, positioned in a tooth socket 2, having a handle 14 at one end connected by a shaft 11 to a plurality of cutting blades 18 that form finlike projections radiating out from the end of the shaft 11 opposite the handle 14, and having a circular guide plane 16 affixed to the shaft 11, such that the guide plane 16 is perpendicular to the long axis of the shaft 11, the guide plane 16 being located at a point between the handle 14 and the cutting blades 18 so that when the pilot tool is introduced into a tooth socket 2, the cutting blades 18 first contact the tooth socket in the apical ⅓ of the tooth socket before the guide plane 16 contacts the countersink 40 in the alveolar crest 32, but as the pilot tool is rotated back and forth in the tooth socket 2, the cutting blades will both debride the soft tissue from the tooth socket 2 as well as shape the bone in the apical region of tooth socket 2, allowing the pilot tool to move into the tooth socket 2 until the guide plane 16 contacts the countersink 40, at which point the pilot tool will be prevented from progressing further into the tooth socket 2.

FIG. 8A illustrates a sectional view of the pilot tool of FIG. 8 inserted into a tooth socket, viewed in the apical direction showing that the cutting blades 18 only cut along the medial-distal diameter, preparing the mesial M and distal D walls of the tooth socket without affecting the buccal B or lingual L walls.

FIG. 9 shows a perspective view of a pilot tool for preparing the middle ⅓ of the tooth socket for insertion of an implant, positioned in a tooth socket 2, having a handle 14 at one end connected by a shaft 11 to a guiding tip 10 and having a plurality of cutting blades 18 that form finlike projections radiating out from the shaft 11 and having a circular guide plane 16 affixed to the shaft 11 such that the guide plane 16 is perpendicular to the long axis of the shaft 11, the guide plane 16 being located at a point between the handle 14 and the cutting blades 18 so that when the pilot tool is introduced into a tooth socket 2, the cutting blades 18 first contact the tooth socket in the vicinity of the middle ⅓ of the tooth socket before either the guide plane 16 contacts the countersink 40 in the alveolar crest 32 or the guiding tip 10 contacts the apex of the tooth socket 2. As the pilot tool is rotated back and forth in the tooth socket 2, the cutting blades will both debride the soft tissue from the middle ⅓ of the tooth socket 2 as well as shape the bone in that region, allowing the pilot tool to move into the tooth socket 2 until the guiding tip 10 contacts the apex of the tooth socket 2 and the guide plane 16 contacts the countersink 40, at which point the pilot tool will be prevented from progressing further into the tooth socket 2.

FIG. 9A illustrates a sectional view of the pilot tool of FIG. 9 inserted into a tooth socket, viewed in the apical direction along the lines of A-A, showing that when the pilot tool is rotated the ends of the cutting blades 18 only cut along the medial-distal diameter 4, preparing the mesial M and distal D walls of the tooth socket without affecting the buccal B or lingual L walls.

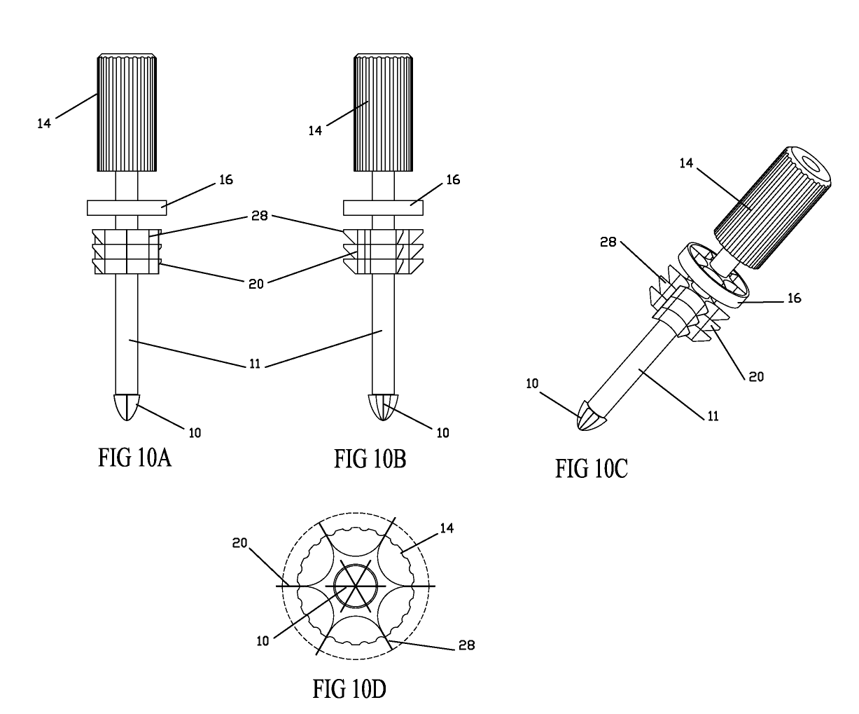

FIGS. 10A-10D illustrate various views of an embodiment of the undercut pilot tool of the present invention. The undercut tool has a handle 14 connected by a shaft 11 to a guiding tip 10. A plurality of long undercut blades 20 and short undercut blades 28 project from the shaft 11 perpendicular to the long axis of the shaft 11 between the guiding tip 10 and the handle 14. The cutting portion of the undercut pilot tool has two series of blades having different dimensions. The short undercut blades 28 have approximately the dimension of the tooth socket at the center of the alveolar crest and the long undercut blades 20 are slightly longer to prepare the undercut notches on the proximal walls. A circular guide plane 16 is affixed to the shaft 11 such that the guide plane 16 is perpendicular to the long axis of the shaft 11, the guide plane 16 being located on the shaft 11 at a point between the handle 14 and the place where the long under cut blades 20 and short undercut blades 28 project from the shaft 11 so that when the undercut pilot tool is introduced into a tooth socket 2, the short undercut blades 28 first contact the socket walls before either the guide plane 16 contacts the countersink 40 in the alveolar crest 32 or the guiding tip 10 contacts the apex of the tooth socket 2. As the pilot is rotated back and forth less than 20 degrees the short undercut blades 28 will cut into the proximal walls of the tooth socket smoothing and creating a convex cut in the proximal walls (a “proximal convex cut”) as the undercut pilot tool advances into the socket until it is stopped by the contact of both guide plane 16 and guiding tip 10. The undercut pilot tool will then be rotated back and forth gradually to more than 60 degrees so that the long undercut blades 20 can engage the proximal walls of the tooth socket and carve out undercut notches on the proximal walls.

FIGS. 11A and 11B show the cross section of a tooth socket 2 before and after a countersink 40 has been placed at the alveolar crest 32. In one embodiment of the methods of the present invention, a countersink 40 is placed in the top surface of the alveolar crest 32, by use of the countersink tool, prior to preparation of the tooth socket for insertion of an implant. The countersink 40 acts as a guiding stop for positioning subsequent preparation tools, such as the pilot tools, as well as the placement of the implant. FIG. 5 shows a perspective view of a countersink tool of the present invention, having a handle 14 connected to a guiding tip 10 by a shaft 11. From the shaft 11 several guide blades 8 and cutting blades 9 radiate outward perpendicular to the shaft 11, such that the apical sides of the guide blades 8 and cutting blades 9 rest upon and attach to a circular band 12 to define a cut plane, where the cutting blades 9 project slightly beyond the diameter of the circular band 12. The circular band 12 preferably has a diameter that approximates the medial-distal diameter 4 of the tooth socket 2 at the alveolar crest 32 so that when the countersink tool is inserted into the tooth socket 2 the circular band 12 rests just within the tooth socket 2 at the alveolar crest 32 and the portion of the cutting blades 9 that project distally beyond the circular band 12 rest just on top of the alveolar crest 32. FIG. 6A shows a sectional view, viewed from above the cut plane 13 in the apical direction, of a countersink tool placed in a tooth socket 2 before the countersink has been cut into the alveolar crest of the tooth socket 2. Without limiting the dimensions of the countersink tool, in this particular embodiment the diameter of the implant intended for the socket is approximately 5 mm, and the diameter of the cut plane 13 of the countersink tool is approximately 5.4 mm. The desired diameter scribed by the cutting blades 9 as the countersink tool is rotated will be slightly larger than the bucco-lingual dimension of the tooth socket 2 at the alveolar crest 32 in order to place a small step, referred to herein as a countersink, on the alveolar crest 32.

FIG. 11A shows the cross section from the buccal view of a single-rooted tooth socket that has not yet been prepared for introduction of an implant. The lining of the tooth socket is covered with soft tissue, mostly periodontal ligament. In a method of the present invention for preparing the tooth socket for placement of the implant, first a countersink tool is placed in the tooth socket and rotated to create the countersink 40 at the alveolar bone crest 32 as shown in FIG. 11B. The apical ⅓ pilot tool is then placed in the tooth socket 2 and rotated to prepare the apical ⅓ of the tooth socket 2 by removing the PLD and other soft tissue as well as shaping this section of the tooth socket 2 to mirror the taper of a dental implant, the results of which are shown in FIG. 11C, the dashed line in FIG. 11C representing the tissue or socket material or both that have been removed. The middle ⅓ pilot tool will similarly be inserted in the tooth socket to prepare the middle ⅓ of the tooth socket for the implant, the results of which are shown in FIG. 11D. The undercut pilot tool is introduced and rotated first approximately 20 degrees back and forth to place a proximal convex cut 42 in the proximal walls so that they can accommodate a cylindrical body of an implant, as illustrated in FIG. 11E, and next rotated approximately 60 degrees back and forth to cut the undercut notches 44 in the proximal convex cut 42 prepared in the proximal walls of the tooth socket 2 as shown in FIG. 11F.

FIG. 12A illustrates a dental implant of the present invention seated to its full length inside a tooth socket 2. This embodiment has parallel ridges 22 along the proximal sides of the implant only, which are intended to fit into undercut notches previously placed in the tooth socket, placed, for example, by using the undercut pilot tool from FIG. 10, when the implant is rotated by a wrench clockwise by 90 degrees.

A hexagonal recess 26 is shown in this embodiment in the top center of the implant to accommodate a complementary sized hexagonal wrench tool that can be used to twist the implant into position in the tooth socket. In a preferred embodiment implants of the present invention also have internal threading (not shown) within a recess in the top center of the implant that is designed to accommodate a screw projecting from an abutment, a restorative tooth, or both, for the attachment of the abutment and crown for final restoration.

FIG. 12C is a perspective view of the implant body 36 and a sectional view of the tooth socket, viewed in the proximal direction of the implant shown in FIG. 12A. The figure displays the space between the implant body 36 and the buccal and lingual cortical bone 38. In a preferred embodiment this space is filled with osteoconductive material to induce the osseointegration of the dental implant.

FIG. 12B illustrates the dental implant body 36 in FIG. 12A after it is rotated clockwise approximately 90 degrees to lock the ridges 22 into the undercut notches 44. The size and design of the ridges 22 on implants of the present invention can be varied to suit a variety of needs, including considerations of the bucco-lingual dimension of the tooth socket, the bone quality, the desired initial retention, providing that the ridges 22 appear only on the sides of the implant body 36 that are intended to contact the proximal walls of the tooth socket when the implant is rotated into position in the socket. For example, if the undercut notches 44 are identical or slightly smaller than the ridges 22 on the implant, the implant will require less force to rotate in order to engage into the proximal walls. If the thread pattern is bigger than the prepared undercut notches, more force will be needed to rotate the implant to engage the ridges 22 into the proximal walls and hence the implant is expected to have stronger initial retention after placement. In cases where undercut notches 44 are not placed in the walls of the tooth socket it is preferred that the ridges 22 on the implant be blade-sharp to ensure that the threads will cut and engage into the proximal walls of the tooth socket as the implant is rotated 90 degrees into position.

While it is standard to tighten devices by rotating clockwise, this invention also contemplates that embodiments of the implant of the present invention may be threaded in reverse so that when the implant is rotated counter clockwise in the tooth socket it is drawn into the socket.

FIG. 13A-13D show different views of an embodiment of the present dental implant that can be installed without the need for placing pre-prepared undercut notches in the proximal walls of the tooth socket. FIG. 13A is a perspective view of a proximal side of an implant of the present invention having an implant apical end 34, an implant body 36, Interrupted circumferential thread 24 along the proximal surface of the implant body 36, and a hexagonal recess 26 on the implant coronal surface. The thread pattern is not continuous, as the Interrupted circumferential threads 24 only span approximately 90 degrees of each of two opposing sides of the implant body 36, which sides represent the two mesio-distal sides of the implant (as determined by the final seated position of the implant after installation into the tooth socket is complete) while the other opposing sides (the bucco-lingual sides) of the implant have no threading. Because of this interrupted thread pattern, the implant can be pressed into the tooth socket while the threads are oriented in the bucco-lingual direction without encountering resistance due to bony structure, then the implant can be secured in the socket by rotating approximately 90 degrees so that the threads engage into the mesio-distal bony walls of the tooth socket. In a preferred embodiment, when the ridges are slanted to provide a screw like travel upon rotation the implant sits slightly above the apex of the tooth socket when first positioned prior to rotation, in order to accommodate the slight advancement of the implant into the socket as it is rotated in the socket to lock it in place. For example, if the threads are 1 mm apart, and advance 1 mm per complete rotation around the body of the implant, then by rotating the implant one quarter turn to lock the threads into the walls of the tooth socket, the rotation will advance the implant approximately ¼ mm and hence the implant would preferably be positioned approximately more than ¼ mm above the apical point of the socket prior to rotation to accommodate the advancement and maximize retention of the implant.

For ovoid tooth socket, its natural morphology will confine the pilot tools and the implant to the center of the tooth socket. When the implant is rotated into the socket the path of resistance is predominantly in the coronal direction. Therefore, in a preferred embodiment, when preparing the tooth socket, light pressure should be applied in the apical direction until the pilot tool is stopped by the guiding plane or the apical stop. The implant should be inserted into the tooth socket smoothly without resistance from bony structures until it has been inserted fully if the tooth socket has been prepared properly in advance with the corresponding pilot tools. If undercut notches are prepared on the proximal walls, the implant can be wrenched clockwise with little resistance to engage into the proximal walls. If there are no pre-prepared undercut notches, more torque will be needed to rotate the implant so that the thread pattern will cut and engage into the walls. The direction of resistance is still coronal so slight apical pressure should again be applied to the implant when it is rotated into the socket.

For trapezoid tooth socket with a bigger buccal half, the path of resistance for the pilot tools will be both coronal and buccal. Therefore, when preparing the tooth socket, light pressure should be applied lingually, as well as apically, to keep the pilot tool at the center of the socket. When placing the implant, it should be pushed slightly against the lingual side when being rotated to engage into the proximal walls. Even though the pilot tools and the implant are pushed against the lingual side, the contact points are still on the proximal walls and hence they should not affect the lingual cortical bone plate.

When the undercut pilot tool is not used to prepare undercut notches on the proximal walls of the tooth socket, an alternative pilot tool is preferably used. This coronal ⅓ pilot tool can be used to ensure the dimension and the taper of the tooth socket will be similar to those of the final implant. This tool is similar to the middle ⅓ pilot tool, but having the cutting blades in the coronal ⅓ of the tooth socket (FIG. 14 & FIG. 14A).

For purposes of determining the appropriate sized implant, particularly when using a kit that contains a plurality of implants of varied sizes, the mesio-distal dimensions of a dental implant of the present invention is preferably chosen to approximate the diameter of the extracted tooth or tooth socket as determined by the mesio-distal dimension taken at the center of tooth socket at the bone crest level. Where ridges are present on the implant, these should not be considered in the measurement, as they are intended to lock into the mesio-distal walls of the tooth socket and preferably will project slightly beyond the mesio-distal dimension. Similarly, in a preferred embodiment, the coronal to apical length of the implant will be selected to approximate the length of the straight portion of the tooth socket, not including any significant bend in the apical region. This dental implant system is expected to reduce problems associated with traditional implants related to sizing, such as the choice of an excessively wide implant resulting in cortical bone plate fracture or perforation, an excessively long implant resulting in violation of the anatomical oral structures including the maxillary sinus, mandibular nerve and mental foramen.

For tooth socket with morphology in FIG. 1A where the proximal dimension is larger than the bucco-lingual dimension, a non rotational dental implant may be used. In this case, the implant only has micro parallel threads and will be inserted along the long axis of the tooth socket. The frictional force from the implant threads pressing into the alveolar bone will retain the implant during the osseointegration. For an even stronger dental implant, a custom shaped dental implant can be utilized.

In a preferred embodiment, the alveolar bone is preserved during and following tooth extraction to ensure sufficient bone structure to shape the bone for insertion of the prefabricated implant. Methods that remove substantial amounts of bone during tooth extraction process may compromise the success of the present dental implant system. Methods of extracting teeth atraumatically and preserving alveolar bone, such as, without limitation, the physics forceps from GoldenMisch (Detroit, Mich.) are preferred.

A few terms are herein defined for clarity:

“Abutment” shall mean the portion that is attached to the implant for the purpose of attaching the final prosthesis such as single crown or bridge.

“Anterior” shall mean toward the front of the mouth.

“Apex” shall mean the very bottom of the root of a tooth or artificial implant.

“Body” of an artificial tooth shall include but shall not be limited to the part of the prosthesis representing a root structure for periodontal or osseointegration or the combined part of the prosthesis representing a root structure for periodontal or osseointegration and a support structure for a crown or a bridge, such as without limitation an abutment.

“Buccal” shall refer to the tooth or root surface lying nearest to the cheeks or to in the direction of the cheeks.

“CAD” shall include but shall not be limited to any and all technology of computer aided design.

“CAM” shall include but shall not be limited to any and all technology of computer aided manufacturing.

“CNC” shall include but shall not be limited to any and all technology of computer numerical control as it relates to manufacturing machinery and systems, including but not limited to rapid prototyping devices and systems.

“Coronal” shall mean toward the crown end of the tooth, “apical” shall mean toward the root end of the tooth, “gingival” shall mean toward the gum (gingiva.)

“Crown” shall mean the portion of an artificial tooth that is visible above the gum line.

“CT” shall include but shall not be limited to any and all technology of computed tomography.

“Dental Implant” or “implant” shall mean an artificial root structure that is placed in or adjacent to the jaw and completely or substantially below the gum line, to which may be attached an artificial tooth.

“Distal” shall mean behind or toward the back of the mouth or away from the midline.

“Extraction socket” shall include prepared or unprepared extraction sockets.

“Furcation” shall mean the anatomical area of a multi-rooted tooth where the roots divide.

“Healing cap” shall mean a type of abutment temporarily attached to the superior part of a dental implant to allow gingival tissues to heal prior to the placement of a permanent abutment.

“Imaging” shall include but shall not be limited to any and all technology of acquiring two-dimensional and/or three-dimensional data of physical objects or parts of a human body.

“Occlusal load” of an implant shall include but shall not be limited to the situation where the occlusal portion of the implant (e.g. the crown portion facing the opponent jaw) is not protected against the load of mastication by additional protective means.

“Interproximal” shall mean the space between adjacent teeth.

“Lingual” shall refer to the area of the tooth root or surface nearest the tongue or in the direction of the tongue.

“Mandibular” shall mean pertaining to the lower jaw.

“Maxillary” shall mean pertaining to the upper jaw.

“Mesial” shall mean toward or close to the midline.

“Occlusal” shall mean the chewing or grinding surface of the bicuspid and molar teeth.

“Osseointegration” shall mean the process of bone growth resulting in the direct contact of the dental implant surface with the bone of the tooth socket.

“Occlusion” shall mean but shall not be limited to the manner the teeth of the upper or lower arch are fitting and coming in contact with each other while the mouth is closed or during chewing. It shall also include the fit and contact of adjacent teeth within one arch.

“Prosthesis” shall mean an artificial replacement for one or more natural teeth.

“Proximal” shall mean in the mesial and/or distal directions, for example, in reference to a tooth socket, proximal shall mean in the direction of either or both of the adjacent teeth.

“Periodontal ligament” shall include but shall not be limited to the fibrous connective tissue (e.g. human gingival fibroblasts) interface usually located between a human tooth and the anatomical structure of the jaw of a human being.

“Soft tissue” shall include but shall not be limited to any soft tissue surrounding a tooth and the jaw bone.

“Replacement”, “to replace”, “to be replaced” shall include but shall not be limited to any substitution, where one object fills the former position of another object. In the context of the foregoing such substitution can be performed at any time, so that for example the term replacement shall not be limited to an immediate act.

“Root” shall mean the part of the tooth or implant that is or is to be placed below the bone level.

“Root void” shall mean the void remaining within the tooth socket from one of the roots of a multi-rooted tooth or by the root of a single rooted tooth.

“Tooth socket” shall mean a cavity in the alveolar process of the jaw formed by the loss or removal of a tooth.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The various embodiments and aspects of embodiments of the invention disclosed herein are to be understood not only in the order and context specifically described in this specification, but to include any order and any combination thereof. Whenever the context requires, all words used in the singular number shall be deemed to include the plural and vice versa. Words which import one gender shall be applied to any gender wherever appropriate. Whenever the context requires, all options that are listed with the word “and” shall be deemed to include the world “or” and vice versa, and any combination thereof. The titles of the sections of this specification and the sectioning of the text in separated paragraphs are for convenience of reference only and are not to be considered in construing this specification.

Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements.

In the drawings and specification, there have been disclosed embodiments of the invention, and although specific terms are employed, the terms are used in a descriptive sense only and not for purposes of limitation, the scope of the invention being set forth in the following claims. It must be understood that the illustrated embodiment has been set forth only for the purposes of example and that it should not be taken as limiting the invention.

In the claims which follow, reference characters used to designate claim steps are provided for convenience of description only, and are not intended to imply any particular order for performing the steps.

The above specification, examples and data provide a description of the manufacture and use of the embodiments of the present invention. While the devices and related methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims. All the patents discussed or cited above are herein incorporated by reference. Where used, the expression “without limitation” means that the options listed are not the only options contemplated by the present invention. However, even where “without limitation” is not stated, it should be appreciated that the particular implementations shown and described herein are not intended to limit the scope of the invention in any way, but are offered only as examples. Indeed, for the sake of brevity, conventional aspects of embodiments of the invention may not be described in detail herein.

1. A dental implant comprising an apical end tapered conical portion axially connected to a coronal end cylindrical body wherein the coronal end cylindrical body comprises: two proximal sides, a mesial side, and a distal side; and wherein the coronal end cylindrical body has a ridge on each proximal side and has no ridges on the mesial side and distal side.

2. The dental implant of claim 1, wherein the coronal end cylindrical body has more than one ridge on each proximal side.

3. The dental implant of claim 2, wherein the ridges project in a 90 degree arc around each proximal side.

4. A method for installing a dental implant into a tooth socket, comprising:
a) providing
i) a tooth socket having proximal walls and bucco-lingual walls,
ii) a dental implant comprising a coronal end, an apical end and an approximately cylindrical portion between said coronal end and said apical end, wherein said approximately cylindrical portion comprises two proximal surfaces, a mesial surface and a distal surface, and wherein the approximately cylindrical portion further comprises a ridge projecting from each proximal surface and no ridge projecting from the mesial surface or the distal surface;
b) placing the dental implant in the tooth socket so that the ridge is oriented toward the bucco-lingual walls; and
c) rotating the implant until the ridge is oriented toward the proximal walls in the tooth socket.

5. The method of claim 4, wherein said tooth socket has a mesiodistal dimension and a buccolingual dimension, and wherein said mesiodistal dimension is shorter than said buccolingual dimension.

6. The method of claim 5, wherein:
a) the tooth socket further comprises a coronal portion, an apical portion, and a middle portion between said apical portion and said coronal portion; and
b) further providing:
i) a countersink tool,
ii) an apical ⅓ pilot tool,
iii) a middle ⅓ pilot tool,
iv) a coronal ⅓ pilot too, and
v) an undercut pilot tool;
c) the method further comprising, before placing the dental implant in the tooth socket,
i) inserting the countersink tool into the socket fully and rotating the countersink tool to create a countersink;
ii) inserting the apical ⅓ pilot tool into the tooth socket and rotating to shape the apical portion of the tooth socket;
iii) inserting the middle ⅓ pilot tool into the tooth socket and rotating to shape the middle portion of the tooth socket;
iv) inserting the coronal ⅓ pilot tool into the tooth socket and rotating to shape the coronal portion of the tooth socket;
v) inserting the undercut pilot tool into the tooth socked and rotating to create an undercut notch in the tooth socket.

7. The method of claim 6, wherein said implant is rotated until the ridge is fully engaged in the undercut notch.

8. The method of claim 7, wherein after the implant is rotated it is held in place by the engagement of the ridge and the undercut notch.

9. A dental implant kit, comprising:
a) A cylindrical tapered shaped implant having two proximal sides, and having threading only on the proximal sides;
b) a countersink pilot tool;
c) a pilot tool shaped to remove tissue and bone from the sides of a tooth socket when rotated; and
d) an undercut pilot tool.

10. The dental implant kit of claim 9, wherein the pilot tool comprises an apical ⅓ pilot tool; a middle ⅓ pilot tool; and a coronal ⅓ pilot tool.

11. The dental implant kit of claim 10, wherein the apical ⅓ pilot tool, the middle ⅓ pilot tool, and the coronal ⅓ pilot tool are each shaped to remove bone from a different portion of a tooth socket.

12. The dental implant kit of claim 9, wherein said undercut pilot tool comprises:
a) a shaft having a first end, a second end, and a long axis;
b) a handle at the first end of the shaft;
c) a guiding tip at the second end of the shaft, wherein a long axis of the undercut pilot shaft extends through the handle, the undercut pilot shaft and the guiding tip;
d) a plurality of long cutting blades, and a plurality of short cutting blades, wherein the long cutting blades and the short cutting blades are affixed to the shaft between the handle and the guiding tip and project out from the shaft substantially perpendicular to the long axis of the shaft.
